(19) United States
(12) Patent Application Publication
(10) Pub. No.: US 2008/0186411 A1
(43) Pub. Date: Aug. 7, 2008

(54) Television receiver, control system and control method

(75) Inventors: Kazumoto Kondo, Tokyo (JP); Takamichi Mitsuhashi, Tokyo (JP); Yasuhisa Nakajima, Kanagawa (JP); Masahiro Nakano, Tokyo (JP); Kazuyoshi Suzuki, Tokyo (JP); Kei Matsubayashi, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/012,552

(22) Filed: Feb. 4, 2008

(30) Foreign Application Priority Data
Feb. 5, 2007 (JP) P2007-026003

(51) Int. Cl. H04N 5/44

(52) U.S. Cl. 348/734; 348/E05.096

(57) ABSTRACT

A television receiver is provided. The television receiver includes a display unit, a remote control signal reception unit, and a control unit. The display unit is configured to display video based on a received or inputted video signal. The remote control signal reception unit is configured to receive a remote control signal. The control unit is configured to control a display on the display unit based on the remote control signal received at the remote control signal reception unit and to determine a transmission source of the remote control signal from the received remote control signal so that the display on the display unit is selected for the determined transmission source from two or more kinds of display prepared for a function.

### CROSS REFERENCES TO RELATED APPLICATIONS

The present invention contains subject matter related to Japanese Patent Application JP 2007-026003 filed in the Japanese Patent Office on Feb. 5, 2007, the entire contents of which being incorporated herein by reference.

### BACKGROUND OF THE INVENTION

1. Field of the Invention:

The present invention relates to a television receiver that is remotely controlled using a remote controller, a control system including the television receiver and the remote controller, and a control method applicable to the system.

2. Description of the Related Art:

Television receivers are generally configured such that a remote controller is used to remotely control the receiver. An infrared signal, for example, is transmitted as a signal from the remote controller, and the television receiver receives the transmitted infrared signal to perform various kinds of control such as power on/off, channel switching, volume up/down, input switching, and function settings.

An example of an electric device remotely controlled by a remote controller is disclosed in Japanese Unexamined Patent Application Publication No. 2003-233977. In this Patent Reference, there is a description of one device operated using a plurality of remote controllers.

### SUMMARY OF THE INVENTION

Television receivers tend to have multiple functions, and accordingly, functions operable by a remote controller also tend to increase. Therefore, the remote controller used for the television receiver tends to have a large number of operation keys arranged corresponding to various functions.

Although it becomes possible to remotely control various functions by providing the remote controller corresponding to such multiple functions, there may be such a case that comparatively simplified functions alone are operated, depending on a user using the television receiver. For example, there are such cases in which an aged person and a child, who may not use a complicated electronic device, only operate basic functions such as power on/off, channel switching, and volume up/down. In such cases, the user may be confused when operating the controller provided with a large number of operation keys, and therefore such remote controller may not be user-friendly.

There is a television receiver distributed to the user with two remote controllers: a multifunctional remote controller having a large number of operation keys and a simplified remote controller having operation keys for basic functions alone.

Thus, the user operating the television receiver can select the remote controller to be used. Accordingly, both the user using advanced functions and the user using basic functions alone can operate the television receiver conveniently by selecting one of the controllers.

However, even in the case of providing two kinds of remote controller as described above, the television receiver only carries out a display that is set in advance and the display depending on the user may not be carried out. Particularly, television receivers in recent years carry out GUI (graphical User Interface) display. In the GUI display, a guide display such as a menu screen corresponding to an operation is shown on the display screen and the desired operation, settings, for example, can be carried out according to the guide display by operating in sequence the operation keys or the like provided on the remote controller. When operating a multifunctional television receiver according to the GUI display, a large number of detailed operations are displayed on the menu screen or the like.

The menu screen showing the large number of detailed operations is not desirable for the user operating the above-described simplified remote controller, because the large number of unnecessary functions may be displayed.

It is desirable to excellently operate a multifunctional device such as a television receiver in both the cases of operating advanced functions and operating basic functions alone.

According to an embodiment of the present invention, there is provided a system including a television receiver, a first remote controller for controlling the television receiver, and a second remote controller for controlling the television receiver.

Whether a remote control signal is received from the first remote controller or received from the second remote controller is determined in the television receiver. The television receiver is controlled based on a command indicated by a code of the received remote control signal. That is, an operation of the television receiver controlled based on the command indicated by the code of the received remote control signal, when determining that the signal is received from the first remote controller, is set differently from the operation of the television receiver controlled, when determining that the signal is received from the second remote controller, according to a result of the determination.

Thus, the display or the like on the television receiver in the case of operating the first remote controller and the display or the like on the television receiver in the case of operating the second remote controller are differently controlled. Accordingly, various display settings corresponding to the kinds of remote controller become possible such that the display corresponding to the multifunctional operation is shown on the screen in the case of operating the first remote controller and the display corresponding to the simplified operation is shown on the screen in the case of operating the second remote controller, for example.

According to the embodiment of the present invention, different displays can be carried out on the television receiver for a plurality of remote controllers provided. Accordingly, the display desirable for the user operating each remote controller can be obtained. Therefore, various displays such as the display for the user operating advanced functions and the display for the user operating basic functions alone can be carried out only by selecting the remote controller to be used. As a result, a favorable display and operation for any user can be obtained.

### BRIEF DESCRIPTION OF THE DRAWINGS

FIG. 1 is an explanatory diagram showing an example of a system configuration according to an embodiment of the present invention.

FIG. 2 is a block diagram showing an example of a configuration of a television receiver according to an embodiment of the present invention.

FIG. 3 is a flow chart showing an example of determination processing according to an embodiment of the present invention.

FIGS. 4A and 4B are explanatory diagrams showing display examples of the whole screen according to an embodiment of the present invention, where FIG. 4A is a display example when an operation is executed using a multifunctional remote controller and FIG. 4B is a display example when the operation is executed using a simplified remote controller.

FIGS. 5A and 5B are explanatory diagrams showing display examples of the whole screen according to an embodiment of the present invention, where FIG. 5A is a display example when an operation is carried out using a multifunctional remote controller and FIG. 5B is a display example when the operation is carried out using a simplified remote controller.

FIGS. 6A to 6D are explanatory diagrams showing display examples of a part of screen according to an embodiment of the present invention, where FIG. 6A is the display example when an operation is executed using a multifunctional remote controller, and FIGS. 6B, 6C and 6D are different display examples respectively when the operation is executed using a simplified remote controller.

FIGS. 7A and 7B are explanatory diagrams showing display examples of a menu screen according to an embodiment of the present invention, where FIG. 7A is a display example when an operation is carried out using a multifunctional remote controller, and FIG. 7B is a display example when the operation is carried out using a simplified remote controller.

FIGS. 8A and 8B are explanatory diagrams showing display examples of a menu screen according to an embodiment of the present invention, where FIG. 8A is a display example when an operation is carried out using a multifunctional remote controller, and FIG. 8B is a display example when the operation is carried out using a simplified remote controller.

FIGS. 9A and 9B are explanatory diagrams showing display examples of menu screens according to an embodiment of the present invention, wherein FIG. 9A is a display example when an operation is carried out using a multifunctional remote controller, and FIG. 9B is a display example when the operation is carried out using a simplified remote controller.

FIG. 10 is a block diagram showing a configuration example of a television receiver according to another embodiment of the present invention.

FIG. 11 is a flow chart showing an example of determination processing according to the example of FIG. 10.

FIG. 12 is a flow chart showing an example of determination processing according to another embodiment of the present invention.

FIG. 13 is an explanatory diagram showing an example of a system configuration according to further another embodiment of the present invention.

### DESCRIPTION OF THE PREFERRED EMBODIMENTS

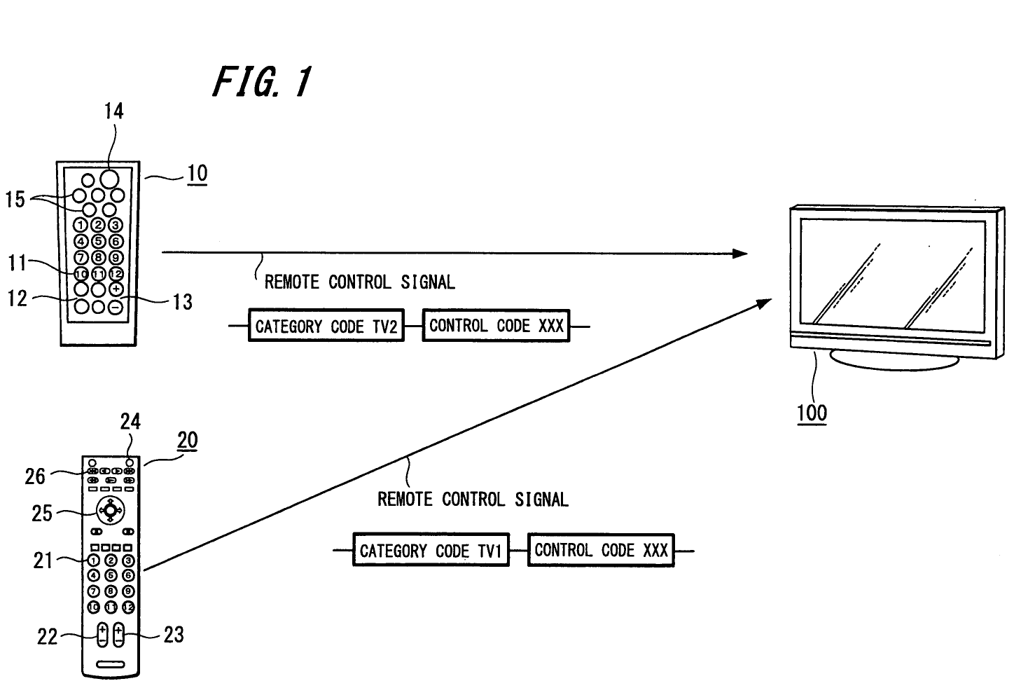

Hereinafter, an embodiment of the present invention is described with reference to FIGS. 1 through 9.

A system according to the embodiment of the present invention includes a television receiver and two remote controllers provided for the television receiver. FIG. 1 is a diagram showing an example of the system configuration.

A television receiver 100 is configured to receive a remote control signal (light) of an infrared signal. A simplified remote controller 10 and a multifunctional remote controller 20 are provided as remote controllers transmitting such remote control signal.

The simplified remote controller 10 includes channel selection keys 11, volume up/down keys 12, channel up/down keys 13, a power key 14, function keys 15 and the like as shown in FIG. 1. The function keys 15 are those prepared corresponding to basic functions provided for the television receiver 100, and include an input switching key, a menu screen display key and the like, for example.

The multifunctional remote controller 20 includes channel selection keys 21, a volume up/down key 22, a channel up/down key 23, a power key 24, an arrow key 25, and function keys 26 as shown in FIG. 1. The arrow key 25 is a key used for performing a GUI operation in which the display and operation are associated such that a selected position (such as a cursor position) is specified on the display screen of the television receiver 100 and further an operation to determine the specified position is performed. As the function keys 26, a larger number of keys than the function keys 15 of the simplified remote controller 10 are provided so that comparatively high-level operation can be performed using the function keys 26. Specifically, in addition to the function keys similar to the function keys 15 of the simplified remote controller 10, other function keys are also provided.

When the user depresses a key arranged in the remote controller 10 or 20, the remote controller 10 or 20 transmits the remote control signal of the control code corresponding to the depressed key as an infrared signal. A category code is added to the control code of the remote control signal transmitted from the remote controllers 10 and 20 as shown in FIG. 1, so that the remote control signal includes a category code and control code transmitted as a unit. In addition, there may be such a case where the category code and the control code are repeatedly transmitted a plurality of times by a key operation at a time.

In this embodiment, the category code of the remote control signal for the simplified remote controller 10 is different from that of the multifunctional remote controller 20.

For example, a category code TV1 for a remote controller of a television receiver, which has been used typically, is set as the category code for the multifunctional remote controller 20. Further, a category code TV2 for a remote controller of a television receiver, which is newly assigned separately from the category code TV1, is set as the category code for the simplified remote controller 10 (refer to FIG. 1). A control code of a common code system is used as the control code transmitted following the category code TV1 and TV2. The control code is data about the code predetermined for each operation of the television receiver such as channel up, channel down, volume up and volume down.

The television receiver 100 accepts the remote control signal of any category code as long as the received remote control signal (light) is of the category code of the remote controller for the television receiver. More specifically, according to the embodiment shown in FIG. 1, the category codes TV1 and TV2 can be received and subsequently the operation control corresponding to the control code transmitted following the category codes TV1 and TV2 is executed.

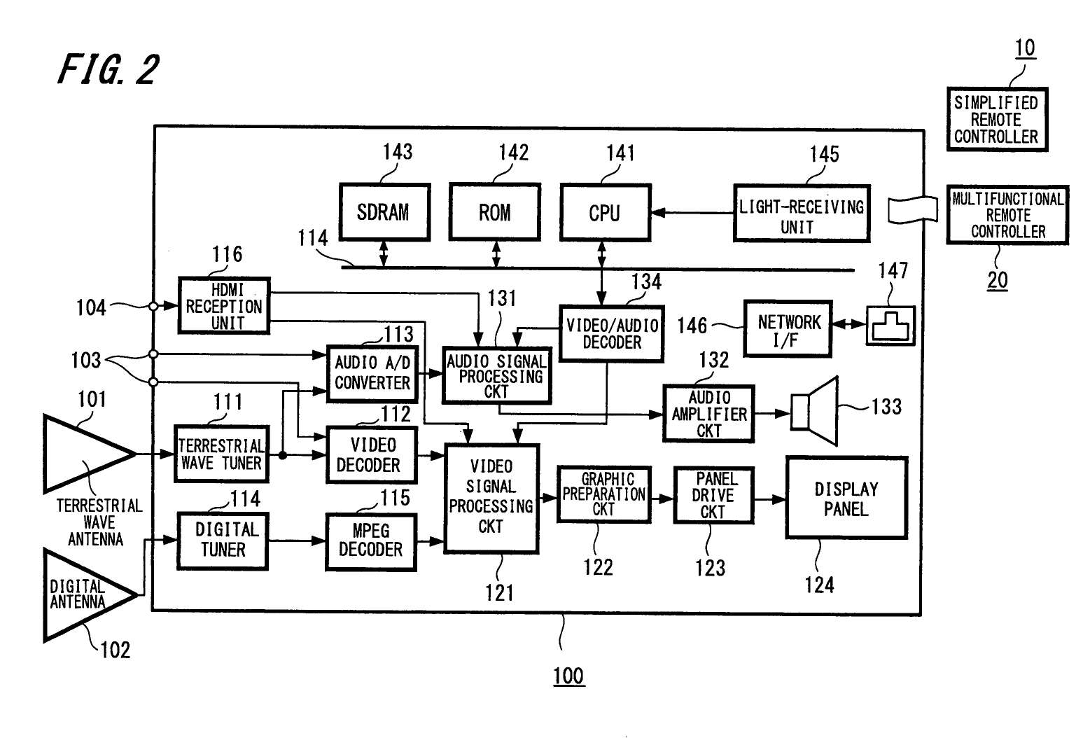

FIG. 2 is a diagram showing an example of an internal configuration of the television receiver 100 according to the embodiment of the present invention. A terrestrial wave antenna 101 and a digital antenna 102 are connected to the television receiver 100 through antenna cables.

A signal received by the terrestrial wave antenna 101 is supplied to a terrestrial wave tuner 111 where reception processing on a broadcast signal of a specified channel is carried out. The received broadcast signal is supplied to a video decoder 112 where video data is demodulated. The video signal demodulated in the video decoder 112 is supplied to a video signal processing circuit 121.

A signal received by the digital antenna 102 is supplied to a digital tuner 114 where reception processing on a broadcast signal of a specified channel is carried out. The received broadcast signal is supplied to an MPEG decoder 115 where processing of decoding the signal from the MPEG standard is carried out. The decoded video data is supplied to the video signal processing circuit 121.

A later-described central processing unit (CPU) 141 controls the channels received by the respective tuners 111 and 114.

Various kinds of video processing for displaying the obtained video signal that is received by the tuner 111 or 114 is carried out in the video signal processing circuit 121. The processed video signal is supplied to a graphic preparation circuit 122 where signal processing for driving a display panel 124 is carried out. The processed signal is supplied to a panel drive circuit 123 to display the video on the display panel 124 based on the video signal. Video display panels using various methods such as a liquid crystal display panel and an organic EL panel can be applied as the display panel 124.

An audio signal obtained by receiving in the terrestrial wave tuner 111 is supplied to an audio analog/digital converter 113 where the audio signal is converted into a digital audio signal. The converted audio signal is supplied to an audio signal processing circuit 131.

The audio signal contained in the broadcast signal received in the digital tuner 114 is separated in the MPEG decoder 115 and then supplied to the audio signal processing circuit 131.

Audio processing such as output audio quality adjustment is carried out in the audio signal processing circuit 131, and the processed signal is supplied as an analog audio signal to an audio amplifier circuit 132. Amplification is carried out in the audio amplifier circuit 132 to drive a speaker, and the amplified audio signal is supplied to a speaker 133 to emit the sound.

In addition, the television receiver 100 of this embodiment includes an input terminal 103 through which analog video signals and audio signals are input from the outside and an HDMI terminal 104 through which digital video signals of HDMI (High-Definition Multimedia Interface) standards and the like are input.

The video signal obtained at the input terminal 103 is supplied to the video decoder 112, and the audio signal obtained at the input terminal 103 is supplied to the audio analog/digital converter 113.

The signal input to the HDMI terminal 104 is supplied to an HDMI reception unit 116. The video signal extracted in the HDMI reception unit 116 is supplied to the video signal processing circuit 121 and the audio signal extracted in the HDMI reception unit 116 is supplied to the audio signal processing circuit 131.

The selection of signals input to the input terminals 103 and 104 is carried out under the control of the central processing unit 141.

Moreover, the television receiver 100 of this embodiment includes a network terminal 147 so that data is exchanged with an external network through a network interface unit 146. In the case where video data or the like is received at the network interface unit 146 via a transmission line connected to the network terminal 147, the received data is supplied to a video/audio decoder 134 through an internal bus 144. The supplied data is decoded in the video/audio decoder 134. The decoded video data is supplied to the video signal processing circuit 121 and the decoded audio data is supplied to the audio signal processing circuit 131. The central processing unit 141 also controls video data received from the external network to be selected and displayed.

The central processing unit (CPU) 141 that controls the operation of respective units of the television receiver 100 according to this embodiment is connected through the internal bus 144 to a ROM 142 and an SDRAM 143 that are memory units so that data can be transferred. Data necessary for the control of operation of the television receiver 100 is stored in the ROM 142 and SDRAM 143. Then, a control command is supplied to respective circuits in the television receiver 100 from the central processing unit 141.

Further, the television receiver 100 includes a light-receiving unit 145 for receiving an infrared signal (light), and a remote control signal that is the infrared signal received in the light-receiving unit 145 is supplied to the central processing unit 141. As a transmission source of the remote control signal in this embodiment, there are two sources, which are the simplified remote controller 10 and the multifunctional remote controller 20 as described above.

The category code and the control code of the received remote control signal are determined in the central processing unit 141, and the corresponding control command is supplied to each unit in the television receiver 100 in the case of determining that the operation in the television receiver 100 may need to be controlled.

Also, various guide displays for user interface may need to be shown on the display panel 124 based on the command from the remote control signal. In such cases, the central processing unit 141 reads display data stored in the ROM 142 or the like, and supplies the data to the video signal processing circuit 121 via the video/audio decoder 134 so that display processing is carried out to display the data on the display panel 124. As the guide display, there are various display modes of adding characters, numerals and graphics to predetermined places on the screen, displaying a menu screen and the like.

According to this embodiment, UI screen data for simplified display and UI display data for regular display have been prepared in the ROM 142 as the display screen for user interface (UI), and the central processing unit 141 selects UI screen data used for display.

It should be noted that the operation of the television receiver 100 is carried out using the remote controller in the configuration shown in FIG. 2, but the television receiver 100 may be provided with operation keys.

Next, an example of operation will be described in the case where the television receiver 100 having the above-described configuration receives a remote control signal from the remote controllers 10 and 20.

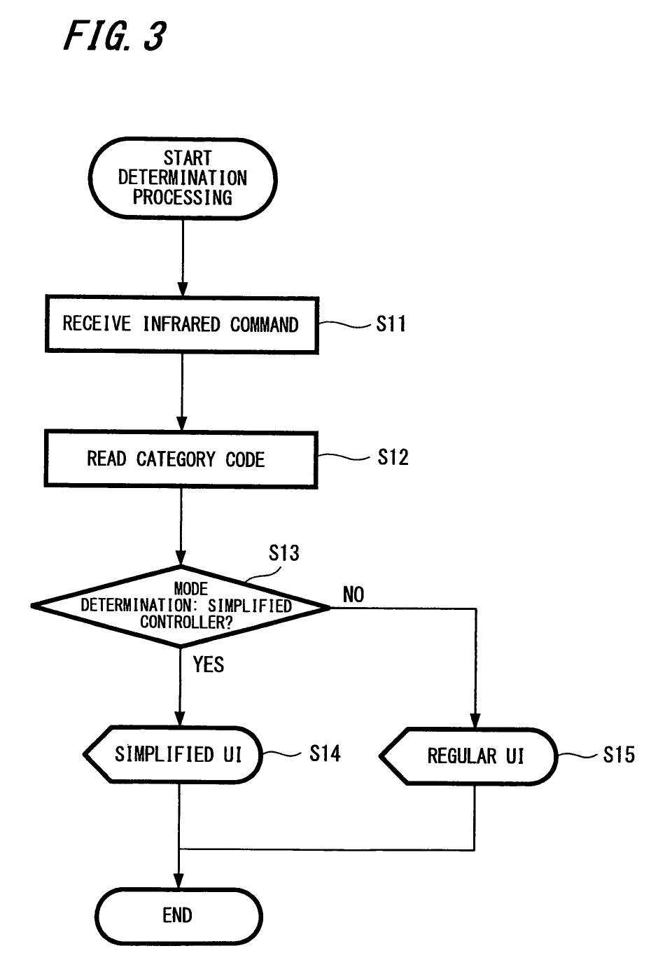

A flow chart in FIG. 3 indicates an example of determining a signal in the central processing unit 141 when the light-receiving unit 145 receives a remote control signal. According to determination processing indicated in FIG. 3, first, it is determined that a command of an infrared signal is received (step S11). Then, the category code included in the received command is read (step S12). Subsequently, it is determined whether the readout category code is the category code for the simplified remote controller or the category code for the regular remote controller (step S13).

If it is determined that the category code is of the simplified remote controller (the code corresponding to the category code TV2 in FIG. 1), the UI screen for simplified display is displayed as the user interface screen (UI screen) on the display panel 124 under the control of the central processing unit 141 (step S14).

If it is determined that the category code is of the regular remote controller (the code corresponding to the category code TV1 in FIG. 1), the UI screen for regular display is displayed as the UI screen on the display panel 124 under the control of the central processing unit 141 (step S15).

As described above, the category code is determined each time a remote control signal is received so as to determine the remote controller from which the signal is transmitted, and then the processing of selecting the display mode based on the determination is carried out.

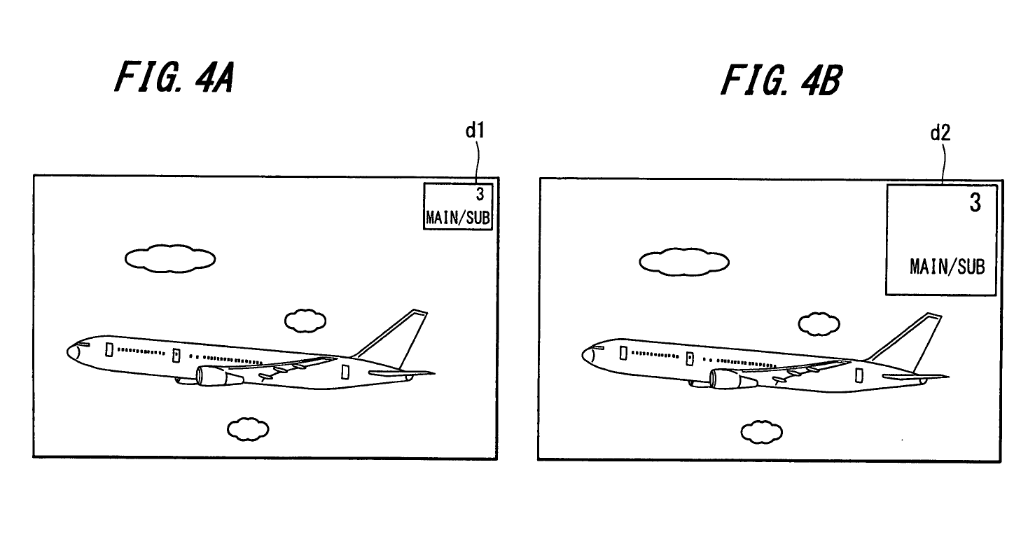

FIGS. 4A and 4B are diagrams showing examples of such display. The examples shown in the respective diagrams represent the case in which the channel switching operation is carried out using the remote controller 10 or 20.

FIG. 4A is the example of the UI screen of regular display, and FIG. 4B is the example of the UI screen of simplified display.

In regular display, a display d1 indicating a channel number and an audio output state is displayed on the upper right of the screen as shown in FIG. 4A. The display d1 here is carried out with a numeral indicating the channel number and a display of “main/sub” indicating a simultaneous output of main audio and sub audio in a predetermined font size.

In simplified display, a display d2 indicating the channel number and the audio output state is displayed in comparatively a large display area on the upper right of the screen as shown in FIG. 4B. The display d2 here is carried out with the numeral indicating the channel number and the display of “main/sub” in a font size substantially larger than those of the display d1 at the time of regular display. Such displays shown in FIGS. 4A and 4B are carried out only for a predetermined period (several seconds, for example) after the channel is switched, for example. Alternatively, such displays are carried out until the remote controller 10 or 20 is operated to cancel the guide display. Here, in the case of the display d2 using the large font size as shown in FIG. 4B, the display d2 may be carried out for several seconds after the channels is switched and afterward the display may be changed to the display d1 using the small font size as shown in FIG. 4A.

With the display processing shown in FIGS. 4A and 4B, the guide display using letters and numerals larger than those of the regular display is automatically carried out in the case where the simplified remote controller 10 shown in FIG. 1 is used for the operation.

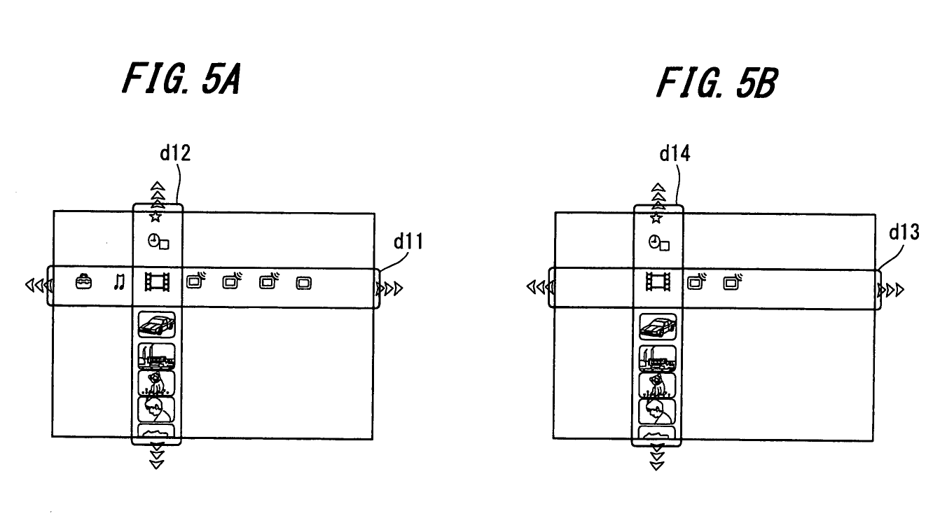

Next, FIGS. 5A and 5B illustrate examples of displaying a menu screen two-dimensionally on the screen of the television receiver 100. The two-dimensional menu screen shown in FIGS. 5A and 5B is called “xross media bar®” or the like. FIG. 5A shows the example of the UI screen of regular display and FIG. 5B shows the example of the UI screen of simplified display.

As shown in FIG. 5A, if the operation of displaying the menu screen is carried out using the multifunctional remote controller 20, the menu screen is displayed such that an item selection display d11 in the horizontal direction and a detailed selection display d12 in the vertical direction for the item being selected in the item selection display d11 orthogonally intersect to each other. Basically, each item can be selected in this state. The remote controller is operated to select an item in the item selection display d11 or the detailed selection display d12, and as a result, the displayed item moves in sequence as indicated by triangular marks shown in FIGS. 5A and 5B.

As shown in FIG. 5B, if the operation of displaying the menu screen is carried out using the simplified remote controller 10, the menu screen is displayed such that an item selection display d13 in the horizontal direction and a detailed selection display d14 in the vertical direction for the item being selected presently in the item selection display d13 orthogonally intersect to each other. The menu displayed is similar to that in FIG. 5A, however, the number of items displayed are reduced from that of the display d11 shown in FIG. 5A so that only the basic selection items or the selection items of frequent use are displayed as the item selection display d13 in the horizontal direction.

In the example of FIG. 5B, the detailed selection display d14 in the vertical direction is the same as the detailed selection display d12 shown in the example of FIG. 5A, however, items less frequently used may be similarly hidden in this detailed selection display d14.

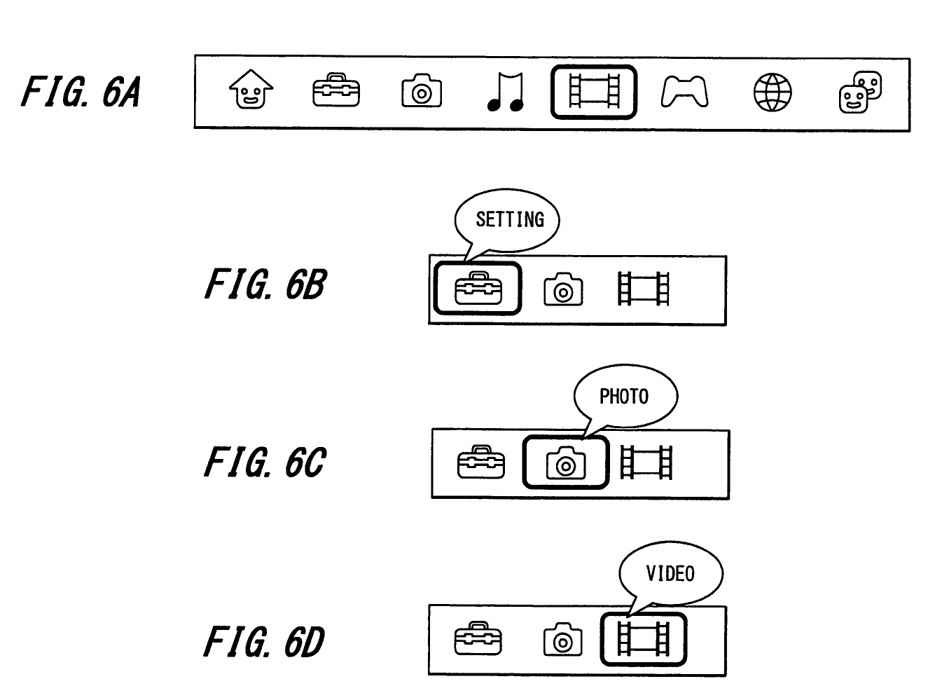

FIGS. 6A, 6B, 6C and 6D show examples in the case where an item selection bar is displayed on a part of the screen of the television receiver 100. The bar displayed in each of FIGS. 6A, 6B, 6C and 6D is set such that categories selectable by the user operation is displayed using icons indicating respective categories at a predetermined position such as the lower side of the screen displaying the video, for example. FIG. 6A shows the example of the bar display screen of regular display, and FIGS. 6B, 6C and 6D are respectively the examples of the bar display screens of simplified display.

As shown in FIG. 6A, if an operation of displaying the bar display screen is carried out using the multifunctional remote controller 20, the list of selectable categories is displayed with icons associated with respective categories arranged in a row. The user selects a desired icon from the displayed icons and performs the operation of determining the selection so that the display changes to another screen in which a detailed operation is performed on the selected item. A comparatively large number of selectable categories are set in the display example shown in FIG. 6A. Further, the selected category is displayed with a mark. In the example shown in FIG. 6A, a video icon shown at an approximately center position is circled with a rectangular mark indicating that the video is presently selected.

If the operation of displaying the bar display screen is carried out using the simplified remote controller 10, the bar display appears as shown in FIGS. 6B, 6C and 6D. Only three kinds of icons, which are the categories frequently used, are displayed in this case. FIGS. 6B, 6C and 6D are diagrams in which different positions are focused, more specifically the categories at different positions are selected, respectively.

As shown in FIGS. 6B, 6C and 6D, in this case, when each category is selected, the selected category is circled with a rectangular mark indicating that the category is selected. Moreover, the description of the category is added to the selected category using characters.

More specifically, a display of “setting” appears using characters when the category of setting is selected as shown in FIG. 6B; a display of “photo” appears using characters when the category of photo is selected as shown in FIG. 6C; and a display of “video” appears using characters when the category of video is selected as shown in FIG. 6D. Since the number of items selected and displayed is reduced and the description of the selected item is displayed as described above, even the user with insufficient knowledge about how to use the screen display can surely operate it according to the guide when the simplified remote controller 10 is used.

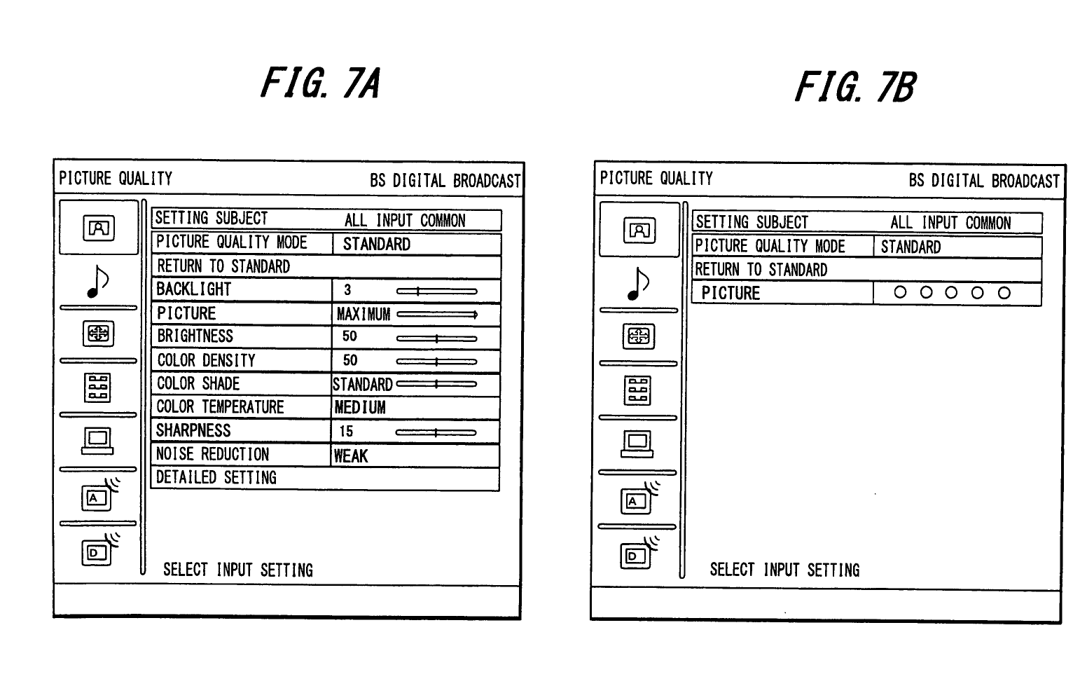

FIGS. 7A and 7B indicate displayed examples of picture-quality setting screens. The picture-quality setting screens are displayed by selecting and determining the setting of picture quality on the menu screen, for example. FIG. 7A shows the example of the picture-quality setting screen of regular display, and FIG. 7B shows the example of the picture-quality setting screen of simplified display.

If an operation of displaying the picture-quality setting screen is carried out using the multifunctional remote controller 20, all the items to be adjusted for the picture quality capable of being set by the user operation for the television receiver 100 and a presently adjusted value of each adjustment item are indicated in the form of list as shown in FIG. 7A.

If an operation of displaying the picture-quality setting screen is carried out using the simplified remote controller 10, an item of picture adjustment, which is a typical adjustment item among the adjustment items set by the user operation as the picture quality for the television receiver 100, and a presently adjusted value for the picture are indicated as shown in FIG. 7B.

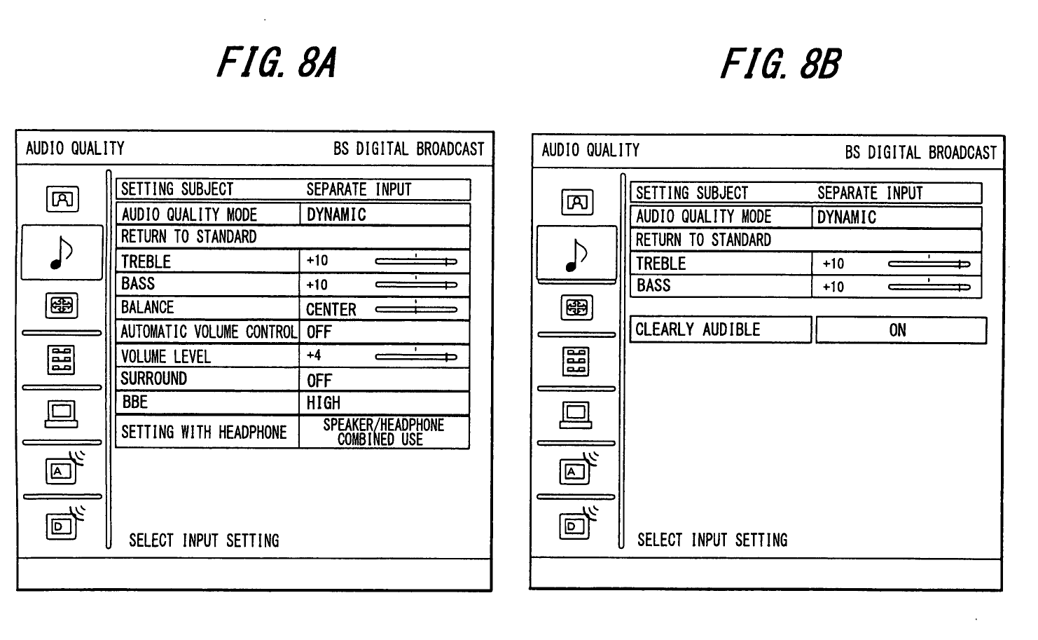

FIGS. 8A and 8B indicate displayed examples of audio-quality setting screens. The audio-quality setting screen are displayed by selecting and determining the setting of audio quality on the menu screen, for example. FIG. 8A shows the example of the audio-quality setting screen of regular display, and FIG. 8B shows the example of the audio-quality setting screen of simplified display.

If an operation of displaying the audio-quality setting screen is carried out using the multifunctional remote controller 20, all the items to be adjusted for the audio quality in the television receiver 100 that can be set by the user operation and the presently adjusted value of each adjustment item are indicated in the form of list as shown in FIG. 8A.

If the operation of displaying the audio quality setting screen is carried out using the simplified remote controller 10, an item of audio output mode, which is a typical adjustment item among the adjustment items set by the user operation as the audio quality for the television receiver 100, and treble adjustment value and bass adjustment value are indicated as shown in FIG. 8B. In addition, the display of “clearly audible” mode, in which a band of voice is raised, is carried out as the audio quality adjustment so that the voice is easily heard, using comparatively large letters so that on-off of such mode can be set in the setting screen of FIG. 8B.

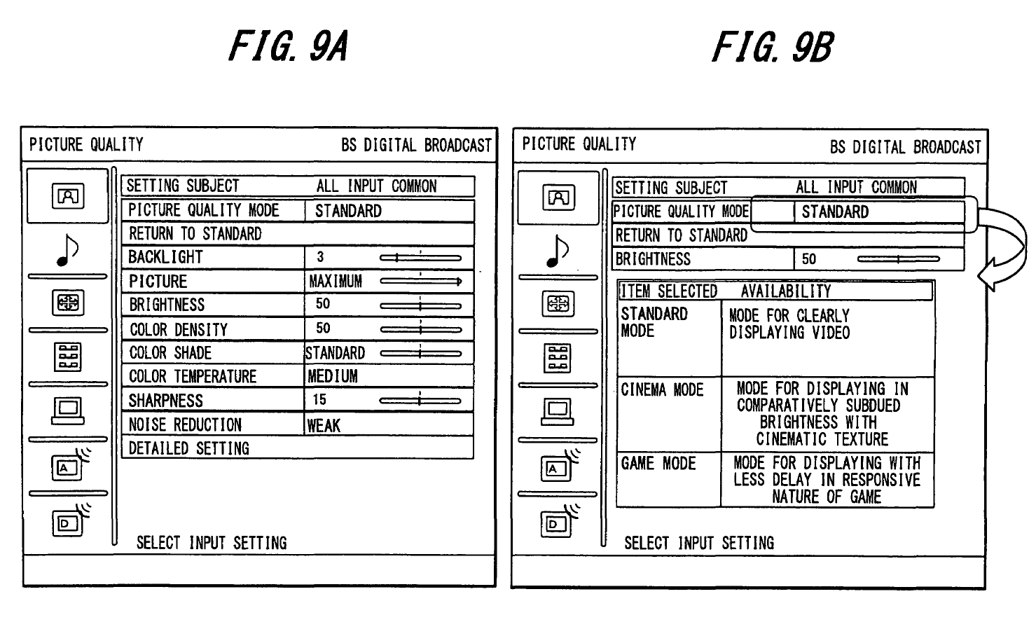

FIGS. 9A and 9B are diagrams showing examples different from those in FIGS. 7A and 7B as the examples of the picture-quality setting screens. In those examples, FIG. 9A is the example of the picture-quality setting screen of regular display, and FIG. 9B is the example of the picture-quality setting screen of simplified display. The picture quality setting screen of regular display shown in FIG. 9A is the same as the picture quality setting screen shown in FIG. 7A.

Further, as shown in FIG. 9B, the picture-quality setting screen using the simplified remote controller 10 is displayed such that a setting state of the picture quality mode and a setting state of the brightness are displayed to indicate each adjusted state. Furthermore, a list of modes capable of being set and a sentence describing the adjusted state of the picture quality in respective modes are displayed in relation to the picture quality mode. In this example, each feature of “standard mode”, “cinema mode”, and “game mode” is described in such sentence.

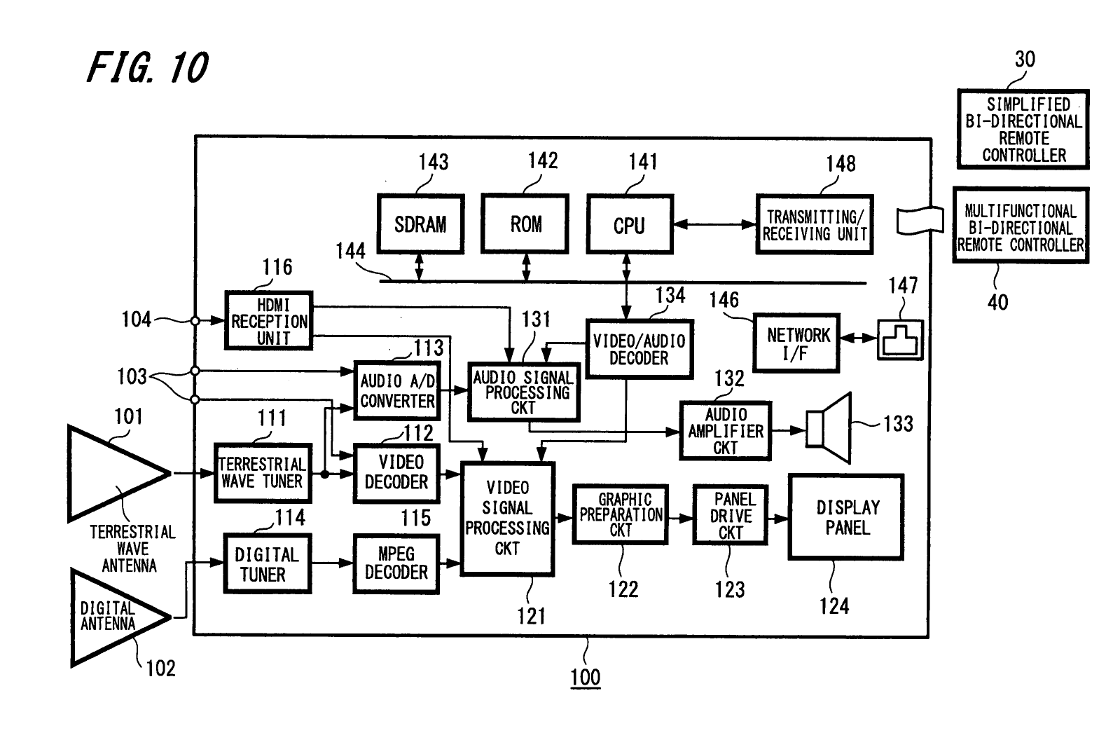

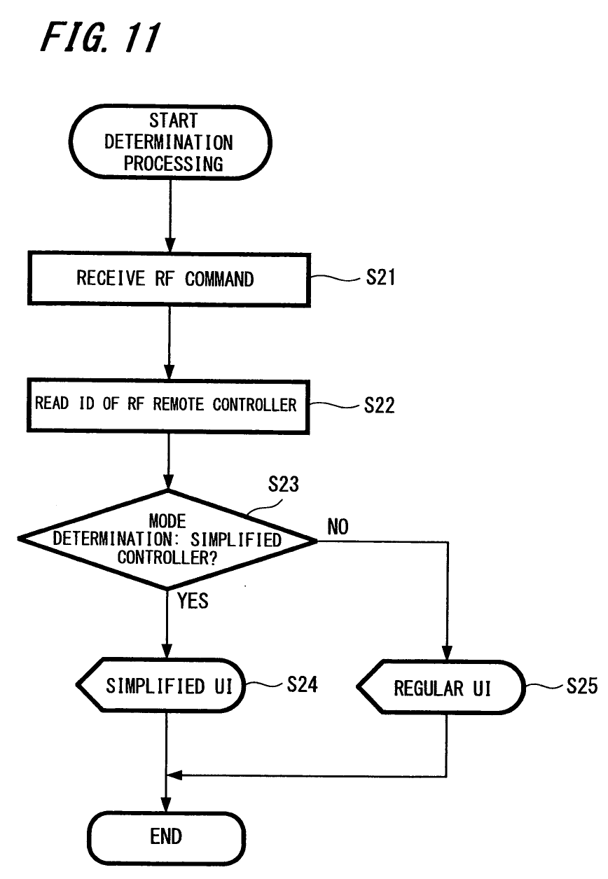

Next, a television receiver and a remote controller according to another embodiment of the present invention is described with reference to FIGS. 10 and 11. According to this embodiment, the remote controller capable of performing bi-directional communications is used as the remote controller for the television receiver.

FIG. 10 is a diagram showing a configuration of the television receiver according to this embodiment. In FIG. 10, the same reference numerals are given to the same parts as those already described in FIG. 2.

The basic configuration of a television receiver 100′ according to this embodiment is the same as the television receiver 100 described in FIG. 2, but a communication unit for the remote control signal is set as a transmitting and receiving unit 148 that receives a wireless signal from the remote controller and transmits the wireless signal to the remote controller. The transmitting and receiving unit 148 is configured as a communication processing unit to transmit and receive the wireless signal of IEEE (Institute of Electrical and Electronic Engineers) 802.11 standard, for example.

Two remote controllers, which are a simplified bi-directional remote controller 30 and a multifunctional bi-directional remote controller 40, are provided for the television receiver 100′. The respective remote controllers 30 and 40 are capable of transmitting/receiving bi-directionally data to/from the transmitting and receiving unit 148 of the television receiver 100′. The respective remote controllers 30 and 40 are configured such that a present operation state of the television receiver transmitted from the television receiver 100′, for example, is received and displayed in addition to transmitting a remote control code by operating the key or the like. Different identification codes (IDs) are respectively set to the two remote controllers 30 and 40, in which processing of adding each identification code to the transmission data is carried out.

The television receiver 100′ is configured such that, when the transmitting and receiving unit 148 receives the remote control signal, the central processing unit 141 detects the identification code to determine the remote controller from which the remote control signal is transmitted. Then, the central processing unit 141 carries out an operation such as different display control based on the determined identification code. As a result, the different display control such as described in FIGS. 4A and 4B through FIGS. 9A and 9B is carried out on each of the two remote controllers based on the determination.

The other units of the television receiver 100′ shown in FIG. 10 are similarly configured to the television receiver 100 shown in FIG. 2.

FIG. 11 is a flow chart showing an example of determination processing carried out by the central processing unit 141 when the remote control signal is received at the transmitting and receiving unit 148 of the television receiver 100′ according to this embodiment. First, the transmitting and receiving unit 148 receives a command from the remote controller (step S21). Then, the central processing unit 141 reads the ID added to the command (step S22). Subsequently, it is determined whether the readout ID is of a simplified bi-directional remote controller 30 or of a multifunctional bi-directional remote controller 40 (step S23).

If the ID is determined to be of the simplified bi-directional remote controller 30, the simplified screen display for the user interface is shown (step S24). If the ID is determined to be of the multifunctional bi-directional remote controller 40, the regular screen display for the user interface is shown (step S25).

Thus, the control suitable for each remote controller can be executed similarly to the above-described example shown in FIGS. 2 and 3, even in the case of the bi-directional remote controller.

It should be noted that only a manner of display or the like in the television receiver is changed in the examples of processing described above. However, the television receiver may switch setting information thereof by determining a source transmitting the received remote control signal, for example.

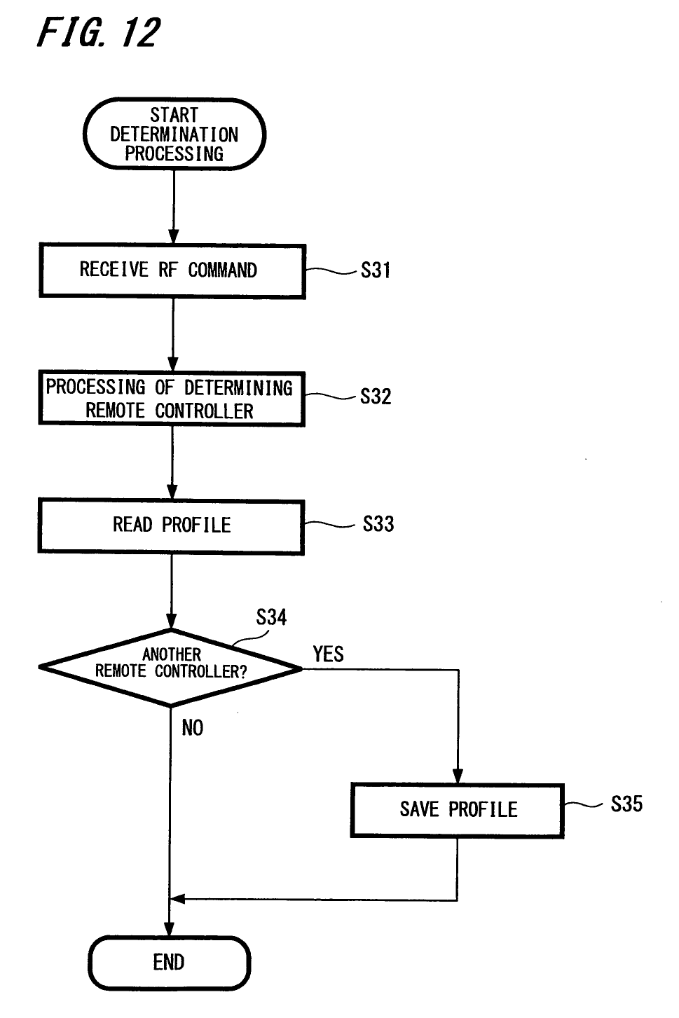

FIG. 12 illustrates a flow chart showing an example of processing in this case. First, the television receiver receives a command from the remote controller (step S31). Then, the remote controller having transmitted the command is determined by reading the ID added to the command, for example (step S32). Subsequently, a profile that is the present setting information corresponding to the determined remote controller is read to carry out the control operation using the readout profile (step S33). Then, it is determined whether the remote control signal received by the television receiver is changed to the signal from another remote controller (step S34). Further, in the case where there is the change, the profile having been used is saved and then the profile of the new remote controller is read to switch over to the processing using the readout profile (step S35).

The setting information is also switched as described above, enabling various setting states of the television receiver to be changed directly for each of the users using the respective remote controllers, for example.

As the setting state that can be changed here, there are the volume value at the time of power-on, the default channel number on power-on, the input switching state, the setting value of screen brightness, and the like.

In the case where the profile is changed as described above, the respective remote controllers may have the same configuration. If different users use the respective remote controllers, each remote controller has different setting corresponding to the respective users.

In addition, the switching is carried out using the two kinds of remote controllers in the examples described above, but the different remote controllers of three kinds or more may be prepared so that the display on the television receiver is changed for each of the remote controllers.

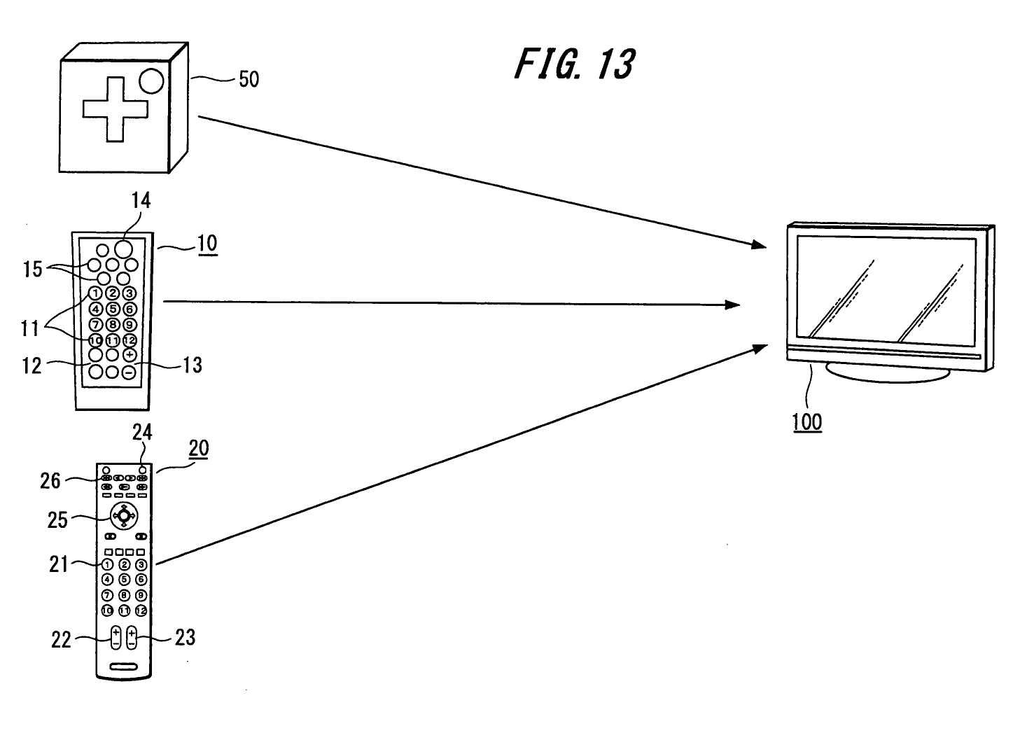

As shown in FIG. 13, a super-simplified remote controller 50 is provided in addition to the above-described simplified remote controller 10 and multifunctional remote controller 20, for example. The super-simplified remote controller 50 has a smaller number of arranged keys than that of those arranged in the simplified remote controller 10. Only the keys for power supply and operating a menu screen are arranged on the remote controller, for example.

Thus, the three kinds of remote controllers are provided and television receiver 100 determines signals from the three kinds of remote controllers. Then, based on the determination, the display mode at the time of displaying the menu screen may be selected from three kinds of modes including regular display mode, slightly simplified display mode and substantially simplified display mode.

Also, such profile as shown in FIG. 12 may be set for each of the remote controllers in the case of providing the three kinds of remote controllers as described above.

Examples of setting of the profiles in the case of the above-described three kinds are described:
Profile of super-simplified remote controller Volume: high, Screen Brightness: Dynamic Mode, User Interface: One-dimensional Display, Input Switching: Video Input 1;
Profile of simplified remote controller Volume: Medium, Screen Brightness: Cinema Mode, User Interface: two-dimensional Display, Input Switching: Video Input 2; and
Profile of multifunctional remote controller Volume: Medium, Screen Brightness: Game Mode, User Interface: Two-dimensional Display, Input Switching: HDMI Input 2.

Here, the dynamic mode for the screen brightness represents the display screen with brightness using grayscale capable of being displayed in the receiver. The cinema mode represents the display screen with comparatively subdued brightness suitable for the cinema expression. The game mode represents the mode in which the video outputted from a video game machine is directly displayed without any processing for obtaining high picture quality or the like. In addition, the input switching in the respective profiles is an input that is selected first when the instruction of the input switching is given by depressing the input switching key on the remote controller.

As described above, the detailed operations of the respective remote controllers vary so that the user for each remote controller may be predetermined and perform the operation, thereby enabling the operation corresponding to the user for each remote controller to be carried out.

Also, in the case where the user for each remote controller is assigned in this manner, the simplified remote controller may be used by children, for example, so that a parental lock may be applied automatically. For example, in the case where such a command as switching the channel is transmitted from the simplified remote controller and received by the television receiver, a restriction is applied so that programs and channels with the restriction on viewer's age are not displayed. Further, in the case where such a command as switching the channel is transmitted from the multifunctional remote controller and received by the television receiver, the channel is switched irrespective of the restriction on viewer's age.

Alternatively, the program may be recommended automatically according to each user's viewing history in the case where the user for each remote controller is assigned. In this case, each user's viewing history is detected by determining the remote controller from which the remote control signal such as the signal of the channel switching is transmitted, thereby determining the user (remote controller) having specified the viewed channel.

Further, an electronic bulletin board may be displayed for each user on the television receiver in the case of assigning the user for the remote controller. More specifically, a message such as an electronic mail for the user assigned to the remote controller is displayed at the time of operating the first remote controller, and a message for the user assigned to the remote controller is displayed at the time of operating the second remote controller. Also, in the case where a message with an image captured with a camera or the like is displayed in a system in which the television receiver is combined with a video camera, the message for the corresponding user is displayed by determining the remote controller.

In addition, the television receiver may change a background image thereof at the time of displaying the menu screen depending on the remote controller used. For example, the wood-tone menu screen is displayed when the menu screen is displayed on the television receiver by the operation of the multifunctional remote controller. The menu screen of another design is displayed when the menu screen is displayed on the television receiver by the operation of the simplified remote controller. The image of each design may be downloaded from the outside via the Internet or the like.

Further, kinds of contents may be selected according to the kind of remote controller. For example, only channels broadcasting a high resolution image such as the high definition image (HD image) may be selected when a high-level remote controller such as the multifunctional remote controller is operated without allowing the selection of the channel broadcasting the image of lower resolution such as the standard image (SD image).

It should be understood by those skilled in the art that various modifications, combinations, sub-combinations and alterations may occur depending on design requirements and other factors insofar as they are within the scope of the appended claims or the equivalents thereof.

What is claimed is:

1. A television receiver comprising:
a display unit configured to display video based on a received or inputted video signal;
a remote control signal reception unit configured to receive a remote control signal; and
a control unit configured to control a display on the display unit based on the remote control signal received at the remote control signal reception unit and to determine a transmission source of the remote control signal from the received remote control signal so that the display on the display unit is selected for the determined transmission source from two or more kinds of display prepared for a function.

2. A television receiver according to claim 1, wherein the two or more kinds of display include characters and numerals displayed in varied sizes.

3. A television receiver according to claim 1, wherein the two or more kinds of display include a display for selecting functions of a first kind and a display for selecting functions of a second kind limited within the functions of the first kind.

4. A television receiver according to claim 1, wherein the two or more kinds of display include a first style of display and a second style of display.

5. A television receiver according to claim 1, wherein the two or more kinds of display include a display for switching to a first input and a display for switching to a second input.

6. A television receiver according to claim 1, wherein the control unit controls an audio output corresponding to the video to be a first audio output or a second audio output in response to the selection of display from the two or more kinds of display.

7. A control system comprising:
a television receiver;
a first remote controller for controlling the television receiver; and
a second remote controller for controlling the television receiver, wherein
the television receiver includes
a display unit configured to display video based on a received or inputted video signal,
a remote control signal reception unit configured to receive a remote control signal, and
a control unit configured to control a display on the display unit based on the remote control signal received at the remote control signal reception unit and to determine whether the remote control signal is transmitted from the first remote controller or transmitted from the second remote controller based on the received remote control signal so that the display on the display unit is selected for the determined remote controller from two or more kinds of display prepared for a function.

8. A control method for a system including a television receiver, a first remote controller for controlling the television receiver and a second remote controller for controlling the television receiver, comprising:
determining in the television receiver whether a remote control signal is received from the first remote controller or a remote control signal is received from the second remote controller and
setting an operation of the television receiver controlled based on a command indicated by a code of the received remote control signal when determining that the signal is received from the first remote controller to be different from the operation of the television receiver controlled when determining that the signal is received from the second remote controller according to a result of the determination.
